(19) United States
(12) Patent Application Publication
(10) Pub. No.: US 2003/0202780 A1
(43) Pub. Date: Oct. 30, 2003

(54) Method and system for enhancing the playback of video frames

(76) Inventors: Matthew Brian Dumm, Fort Collins, CO (US); Gregory William Thelen, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/133,051

(22) Filed: Apr. 25, 2002

(51) Int. Cl. H04N 5/91

(52) U.S. Cl. 386/112

(57) ABSTRACT

Method and system for interpolating video frames are described in a system for enhancing video playback. The interpolation mechanism generates at least one interpolated frame between a first actual frame and a second actual frame. First, the first actual frame is fetched from, for example, a frame buffer or local storage. Second, the second actual frame is also fetched from, for example, a frame buffer or local storage. Then, a determination is made whether or not to generate one or more intermediate frames. If so, an intermediate frame is interpolated based on the first actual frame and the second actual frame. Finally, all individual frames are optionally clarified or enhanced before being sent to a consumer of the stream of frames.

### FIELD OF THE INVENTION

The present invention relates generally to the display of video, and more particularly, to a method and system for interpolating video frames and improving the quality of existing frames.

### BACKGROUND OF THE INVENTION

With the growth of the Internet and the increase in computing power in terms of processor speed and memory, there has been a corresponding increase in the use of video to communicate ideas and transmit information. For example, many websites now have content in the form of video files, such as AVI files, MPEG files, MOV files, and RM files. Also, many web sites offer streaming video, where the video is stored at a server and the video information is streamed to clients through the Internet.

Unfortunately, the quality of the video is often adversely affected by a number of different factors. One factor that decreases video quality is the quality of the network connection. For example, a poor network connection or a severely congested network can lead to a very jittery video, since in times of net congestion it may be impossible to keep a video player's pre-playback buffer full.

Currently, there are transmission formats that can automatically change the transmission bandwidth when a network is congested or when a client informs the server that the client's buffer is not getting filled quickly enough. In response, the server of the streaming video can lower the resolution of the video, lower the frame rate, or take other actions to lower the bandwidth required for the video stream, allowing the player's buffers to fill up again.

Unfortunately, the transmission format does not provide a client-side mechanism to improve video quality of frames that have already been received. Accordingly, a mechanism for improving video quality at the client is desirable.

Based on the foregoing, there remains a need for a mechanism that improves the quality of the display of video and that overcomes the disadvantages set forth previously.

### SUMMARY OF THE INVENTION

According to one embodiment, a method and system for interpolating video frames and improving the quality of existing frames are described. The interpolation mechanism generates at least one interpolated frame between a first actual frame and a second actual frame. First, the first actual frame is fetched from, for example, a frame buffer or local storage. Second, the second actual frame is also fetched from, for example, a frame buffer or local storage. Third, a determination is made whether to generate one or more intermediate frames. If so, one or more intermediate frames are generated based on the first actual frame and the second actual frame.

Other features and advantages of the present invention will be apparent from the detailed description that follows.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates a block diagram of a system that includes a mechanism to improve video quality according to one embodiment of the present invention.

FIG. 2 illustrates a block diagram of another system that includes a mechanism to improve video quality according to a second embodiment of the present invention.

FIG. 3 illustrates in greater detail the playback enhancement module of FIGS. 1 and 2 according to one embodiment of the present invention.

FIG. 4 illustrates the processing steps for frame interpolation according to one embodiment of the present invention.

FIG. 5 illustrates the processing steps for frame interpolation that detects the movement of objects between frames according to one embodiment of the present invention.

FIG. 6 illustrates a single exemplary interpolated frame generated by the frame interpolating mechanism of the present invention that employs fading technology.

FIG. 7 illustrates two exemplary interpolated frames generated by the frame interpolating mechanism of the present invention that employs fading technology.

FIG. 8 illustrates an exemplary interpolated frame generated by the frame interpolating mechanism of the present invention, where the shape and color of the moving object is the same in the first frame and the second frame.

FIG. 9 illustrates exemplary interpolated frame generated by the frame interpolating mechanism of the present invention, where the shape of the moving object is the same in the first frame and the second frame, the color of the moving object changes between the first frame and the second frame.

FIG. 10 illustrates exemplary interpolated frame generated by the frame interpolating mechanism of the present invention, where the color of the moving object is the same in the first frame and the second frame, but the shape of the moving object changes between the first frame and the second frame.

FIG. 11 illustrates exemplary interpolated frame generated by the frame interpolating mechanism of the present invention, where the object rotates between the first frame and the second frame.

FIG. 12 illustrates another exemplary interpolated frame generated by the frame interpolating mechanism of the present invention, where the color of the moving object is the same in the first frame and the second frame, but the shape of the moving object changes between the first frame and the second frame.

### DETAILED DESCRIPTION

A method and system for interpolating video frames are described, as part of a system for enhancing the quality of playback of compressed video. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Local Storage Embodiment

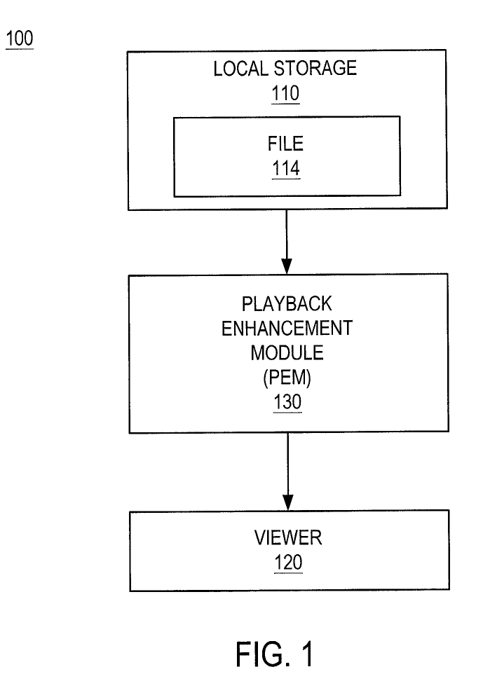

FIG. 1 illustrates a block diagram of a system in which the mechanism to improve video quality. In the first embodiment, the video data is saved to a local storage (e.g., a local hard disk) and played back from the local storage. Specifically, FIG. 1 illustrates a block diagram of a first system 100 configured in accordance with one embodiment of the present invention in which the frame interpolator of the present invention can be implemented. The first system 100 includes a local storage 110 (e.g., a hard disk) that includes a local file 114 (e.g., an MPEG movie file). The first system 100 also includes a video viewer 120 for use in displaying the video. The video viewer 120 can be, for example, a Microsoft MediaPlayer video player, a RealPlayer video player available from RealNetworks of Seattle, Wash., or a Quicktime player available from Apple, Inc. of Cupertino, Calif. The first system 100 also includes a playback enhancement module (PEM) 130 of the present invention. The playback enhancement module 130 is a mechanism that utilizes excess computing power at the receiver to enhance the end user's experience of the video stream. For example, the PEM 130 in accordance with the invention can improve the stream's clarity, resolution, frame rate, or a combination thereof. In one example, the frame interpolator is implemented by a personal computer (PC) that executes software for performing the enhancement of the video stream with available or idle processing power.

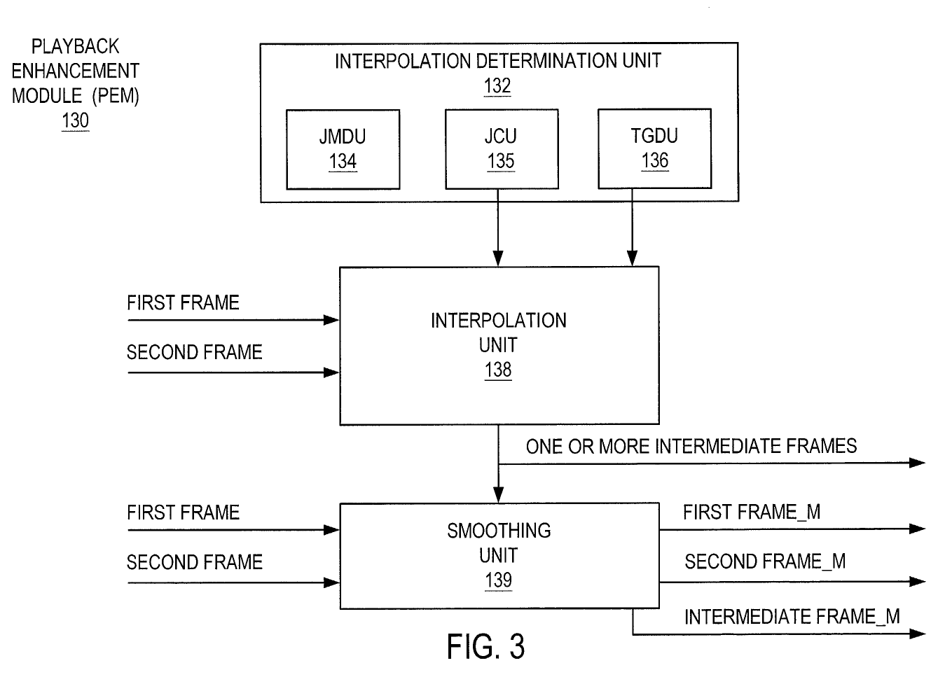

Referring to FIG. 3, the playback enhancement module 130 includes a interpolation determination unit 132 for determining when to generate intermediate frames between a pair of frames. The interpolation determination unit 132 includes a jumpiness measure determination unit (JMDU) 134 for calculating a jumpiness measure of two frames and a jumpiness comparison unit (JCU) 135 for determining if the calculated jumpiness measure exceeds a predetermined jumpiness threshold. The jumpiness threshold is related to how jittery or “jerky” the playback of the video stream experienced by the user. When the jumpiness measure for two frames exceeds the predetermined jumpiness threshold, one or more intermediate frames are generated. Otherwise, the two frames may be displayed without the addition of any intermediate frames. However, other signal processing may be performed on one or more of the two frames to enhance the playback thereof as described hereinafter.

The interpolation determination unit 132 can also include a time gap determination unit (TGDU) 136 for calculating a time gap between two actual frames and if the time gap is greater than a predetermined time threshold (e.g., milliseconds), for generating one or more intermediate frames to be inserted between the two actual frames during playback.

The playback enhancement module 130 also includes an interpolation unit 138 for generating one or more intermediate frames (e.g., interpolated frames) based on a pair of frames.

The playback enhancement module 130 also includes a smoothing unit 139 for performing signal processing on each actual frame to further enhance the quality of the video playback. For example, individual frames in a compressed video stream may be “blocky” due to artifacts of the compression. In this case, the idle computing power of the receiver may be used to smooth out the individual frames with these artifacts. By using edge-smoothing technology, the smoothing unit 139 in accordance with the invention can enhance blocky video feeds in real-time.

The playback enhancement module 130 can be implemented with software, hardware, firmware, or a combination thereof. The playback enhancement module 130 of the present invention can be implemented as a component that is separate from the video viewer or integrated therewith.

Streaming Video Embodiment

In the second embodiment, the video data is streamed directed from a server to a frame buffer. An exemplary streaming video protocol is the Advanced Streaming Format (ASF) that is available from Microsoft Inc., of Redmond, Wash. The MediaPlayer viewer that is also available from Microsoft Inc., of Redmond, Wash., plays ASF files.

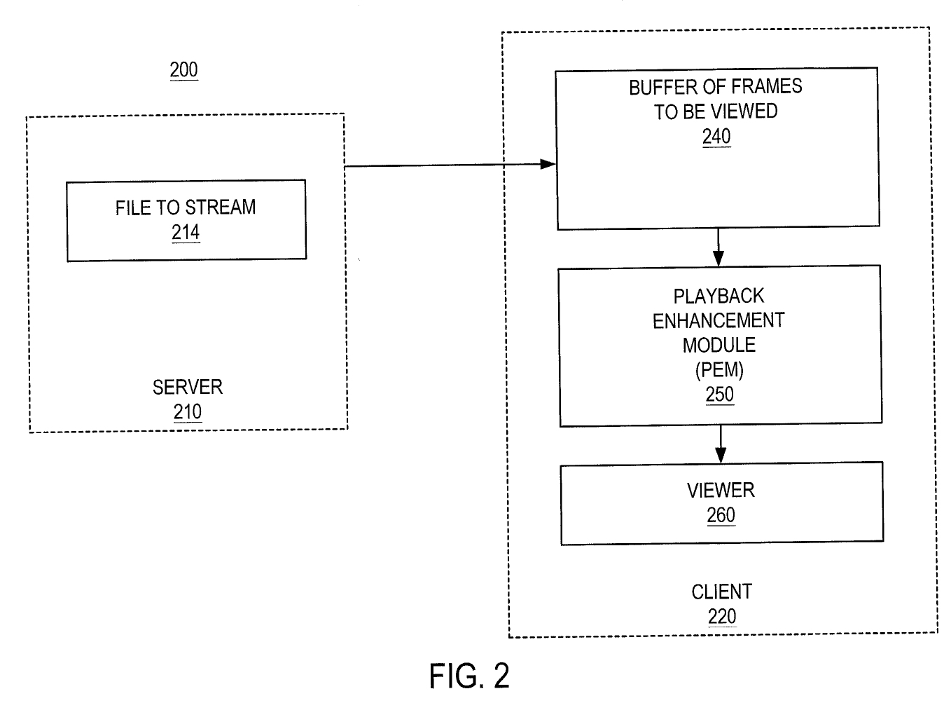

FIG. 2 illustrates a block diagram of a second system 200 configured in accordance with an alternative embodiment of the present invention in which the frame interpolator of the present invention can be implemented.

The system 200 includes a source 210 for providing a video stream. For example, the source 210 can be a server, a transmitter, a buffer that stores frames to be viewed, or a combination thereof. The server 210 can include a video file 214 that may be streamed to clients 220 through a network 230. For example, the video file 214 may have an ASF format.

A decoder is optionally provided for receiving a compressed video stream and decoding the compressed video stream.

The client 220 includes a frame buffer 240 that stores frames to be viewed. The client 220 also includes a playback enhancement module (PEM) 250 that is configured according to one embodiment of the present invention. The PEM 250 of the present invention generates interpolated frames so that quality of the displayed video is improved. As noted previously, the quality of the video is often adversely affected by poor network conditions (e.g., a severely congested network) resulting in a lower bandwidth (more jittery) video stream. The PEM 250 of the present invention improves video quality by generating interpolated frames that may smooth out an otherwise jittery video.

A video viewer 260 is also provided for receiving and displaying video files.

Frame Interpolation Processing

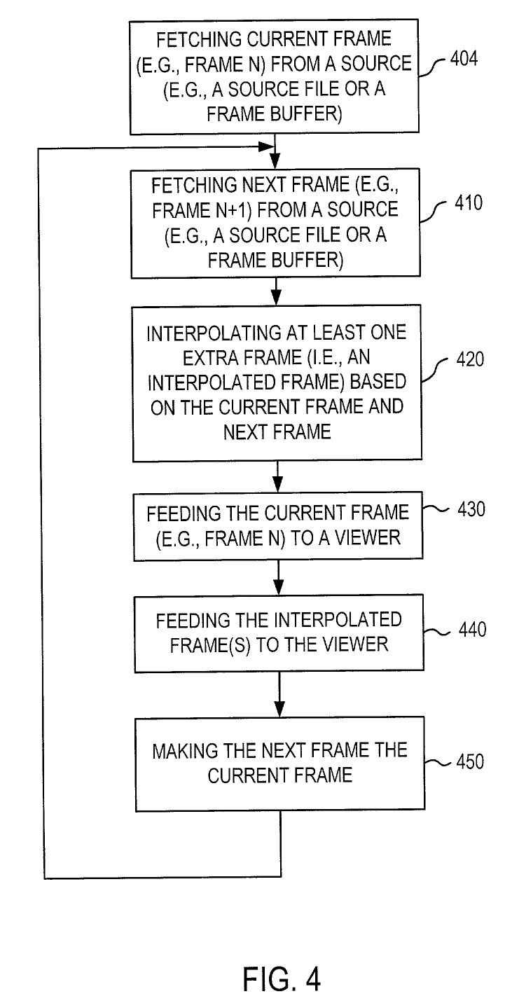

FIG. 4 illustrates the processing steps performed by the frame interpolator of FIG. 1 and FIG. 2. In step 404, a current frame is fetched from a source (e.g., a source file or a frame buffer). In step 410, a next frame (e.g., frame(n+1)) is fetched from the source (e.g., a source file or a frame buffer). In step 420, at least one extra frame (i.e., an interpolated frame) is generated based on the first and second frames. It is noted that one or more interpolated frames may be generated. Interpolated frames are those frames that are in addition to those frames stored in a local source or a frame buffer, which are hereinafter referred to as actual frames. These interpolated frames are then displayed between the first frame and a second frame as described hereinafter.

In step 430, the first frame (e.g., frame n) is provided to the viewer. In step 440, the one or more interpolated frames are provided to the viewer. In step 450, the next frame is made the current frame. Processing then proceeds to step 410. Steps 410 to 450 are repeated for each frame. For example, the next pair of frames upon which this process is repeated is frame(n+1), which becomes the current frame and frame(n+2), which becomes the next frame. The feeding of the next actual frame (n+1) to the viewer occurs in step 430 of the next iteration, after fetching frame(n+2) and interpolating between frame(n+1) and frame(n+2).

Frame Interpolation with Fading Technology

This example employs “fading” technology. For each pixel in the first frame and the second frame, an intermediate pixel is generated. Specifically, the color intensity of the current pixel in the interpolated frame is generated based on the color intensity of the pixel in the first frame and the color intensity of the pixel in the second frame (hereinafter referred to as morphing frame interpolation).

In a red, green, blue (RGB) color system, the following exemplary steps may be performed. First, a red intensity for the current pixel is generated by the following expression:

Interpolated_pixel (red intensity)=0.5(red intensity of pixel from first frame(“before red intensity”))+0.5(red intensity of pixel from second frame (“after red intensity”)).

Next, a green intensity for the current pixel is generated by the following expression: Interpolated_pixel (green intensity)=0.5(green intensity of pixel from first frame (“before green intensity”))+0.5(green intensity of pixel from second frame (“after green intensity”)).

Then, a blue intensity for the current pixel is generated by the following expression: Interpolated_pixel (blue intensity)=0.5(blue intensity of pixel from first frame (“before blue intensity”))+0.5(blue intensity of pixel from second frame (“after blue intensity”)).

It is noted that other expressions may be used to generate the intensity of the pixels of the interpolated frame(s). These expressions may include average expressions, weighted average expressions, or any of a variety of other “smarter” image processing techniques. The example of intensity-averaged fading between actual frames is provided as one example only.

It is further noted that although the example given by FIG. 4 is the formula for interpolating one frame, more than one frame may be interpolated between two actual frames by simple extension of the averaging algorithm.

It is further noted that the determination of color intensity for the pixels of the interpolated frame can involve other intensity calculations that depend on the particular color scheme employed by the display. For example, in a CMY color system, each of the intensities corresponding to these colors may be utilized to generate CMY intensity for each pixel in the interpolated frame.

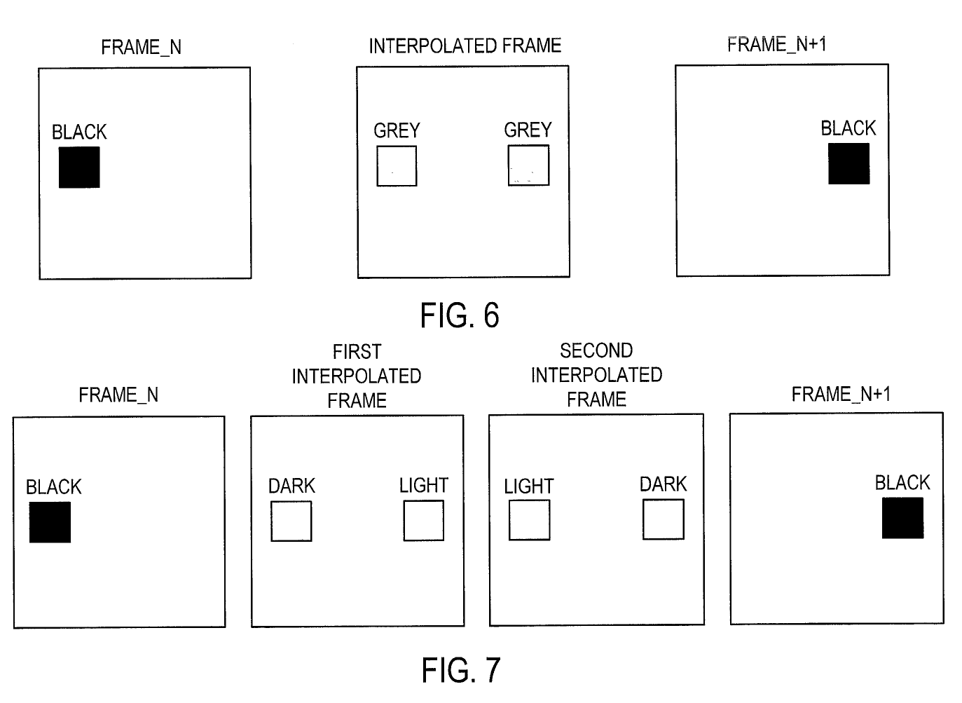

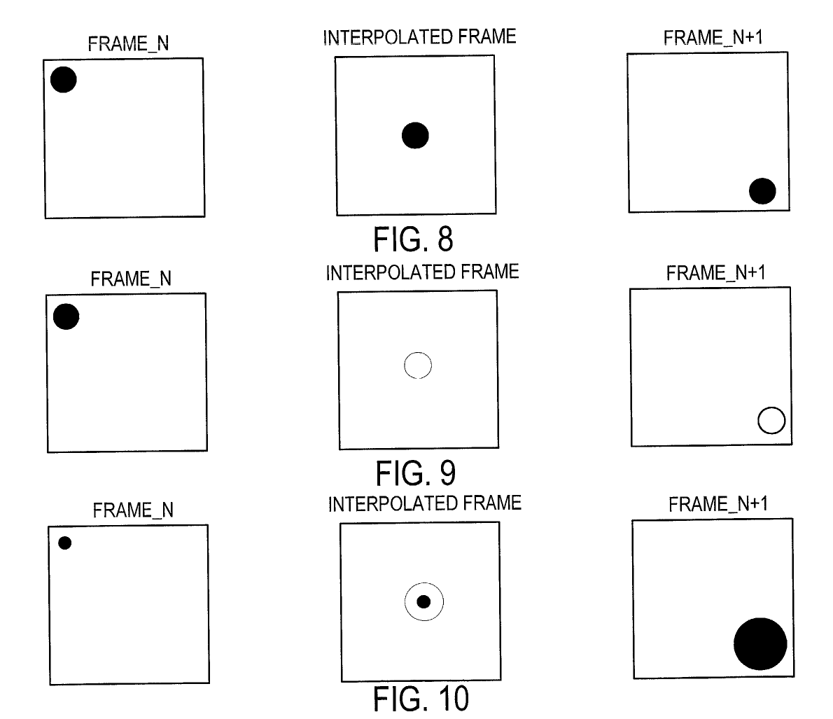

FIG. 6 illustrates a single exemplary interpolated frame generated by the frame interpolating mechanism of the present invention that employs fading technology. FIG. 7 illustrates two exemplary interpolated frames generated by the frame interpolating mechanism of the present invention that employs fading technology. FIG. 8 illustrates an exemplary interpolated frame generated by the frame interpolating mechanism of the present invention, where the shape and color of the moving object is the same in the first frame and the second frame. FIG. 9 illustrates exemplary interpolated frame generated by the frame interpolating mechanism of the present invention, where the shape of the moving object is the same in the first frame and the second frame, the color of the moving object changes between the first frame and the second frame.

Frame Interpolation with Morphing Technology

As an alternative to the simple fading of one frame into another, described previously, a smarter “morphing” step may be used to generate the intermediate frame. In this morphing step, a plurality of feature points are identified and located within the original frames. An intermediate image is interpolated based on the relative motions of the plurality of feature points between the first frame and the second frame.

Motion Detection-Based Frame Interpolation

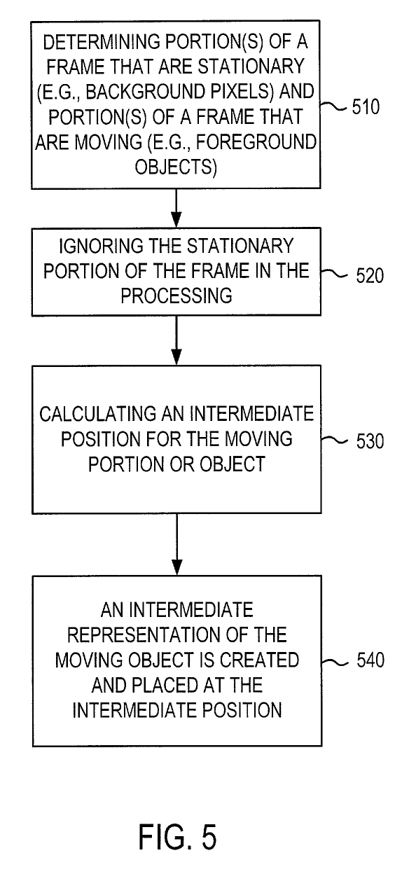

FIG. 5 illustrates the processing steps for frame interpolation that detects the movement of objects between frames according to one embodiment of the present invention. In step 510, determining the portions of a frame that are stationary (e.g., background pixels) and portion of a frame that are moving (e.g., foreground objects). In step 520, the stationary portion of the frame is ignored in the processing.

In step 530, calculating an intermediate position for the moving portion or object. The intermediate position may be, for example, halfway between the initial position in a first frame and the final position in a second frame when a single interpolated frame is generated. When two interpolated frames are employed, the intermediate position may be at ⅓ and ⅔ of the distance between the initial position in a first frame and the final position in a second frame. It is noted that the intermediate positions may be based on the number of interpolated frames to be generated between the first frame and the second frame. For example, for x interpolated frames, the following expression may be utilized to calculate the intermediate positions at each interpolated frame: (1/x, 2/x, . . . (x-1)/x of the way between the start point and the end point). It is further noted that the intermediate locations along a projection of the path of the moving element may be un-equally spaced. For example, the distance between intermediate locations may be derived by employing a non-linear expression.

In step 540, an intermediate representation of the moving object is created and placed at an intermediate position. Step 540 can be implemented in a variety of ways. For example, when the moving object in the first frame is identical to the moving object in the second frame, the first moving object (or the second moving object) is copied and placed at the intermediate position determined in step 530. An example of this case is illustrated in FIG. 8. Referring to FIG. 8, the moving object is a black circle with the same size in both the first frame and the second frame. The interpolated frame includes the black circle at the intermediate position.

In a second example, when the moving object in the first frame is different from the moving object in the second frame, a fading technique, as described previously, is applied to generate an intermediate object. The intermediate object is then placed at the intermediate position determined in step 530. An example of the fading case is illustrated in FIG. 9. Referring to FIG. 9, the moving object is a black circle in the first frame and a white circle in the second frame. The interpolated frame includes a gray circle (e.g., an average of the intensity of the pixels of the circle) at the intermediate position.

In a third example, when the moving object in the first frame is different from the moving object in the second frame, another fading technique, as described previously, is applied to generate an intermediate object. The intermediate object is then placed at the intermediate position determined in step 530.

FIG. 10 illustrates exemplary interpolated frame generated by the frame interpolating mechanism of the present invention, where the color of the moving object is the same in the first frame and the second frame, but the shape of the moving object changes between the first frame and the second frame.

Referring to FIG. 10, the moving object is a small black circle in the first frame and a larger black circle in the second frame. The interpolated frame includes an intermediate faded circle (e.g., an average of the intensity of the pixels of the circles) at the intermediate position.

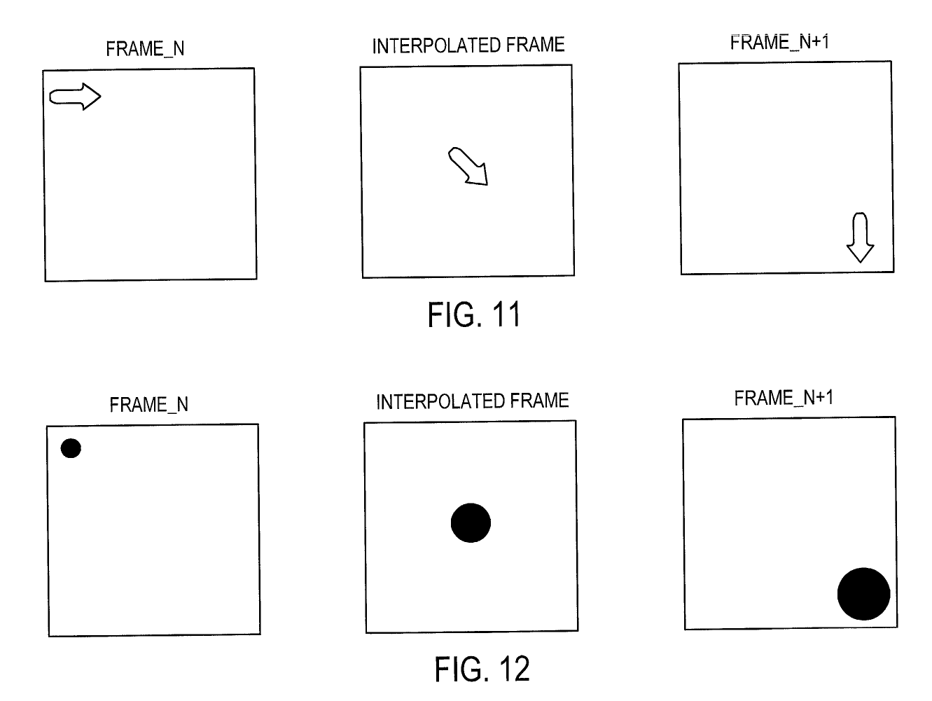

In a fourth example, when the moving object in the first frame is different from the moving object in the second frame, a “smart” morphing technique is applied to generate the intermediate representation of the moving element for the interpolated frame. FIG. 11 illustrates another way of creating the intermediate object that can be utilized in step 540 in which the moving object is rotating. FIG. 11 illustrates exemplary interpolated frame generated by the frame interpolating mechanism of the present invention, where the object rotates between the first frame and the second frame.

A simple fade between the two frames would result in a blurry intermediate moving element. In contrast, a smarter morphing algorithm, as applied to FIG. 11, detects the edge shape of the moving object and determines that the shape is rotating based on the identification and analysis of feature points within the image. The morphing algorithm then uses this information to create an intermediate shape for the interpolated frame. This intermediate shape is then placed at an appropriate intermediate location as described above.

In a fifth example, when the moving object in the first frame is different from the moving object in the second frame, a “smart” morphing technique may also be applied to generate the intermediate representation of the moving element for the interpolated frame. FIG. 12 illustrates another exemplary interpolated frame generated by the frame interpolating mechanism of the present invention, where the color of the moving object is the same in the first frame and the second frame, but the shape of the moving object changes between the first frame and the second frame.

Referring to FIG. 12, another morphing technique is illustrated that detects the edges and shape of the object and creates an intermediate shape based on analysis of the relative locations of feature points within the image. In this case, a small circle is found to be growing while it moves. Morphing technology creates a circle of intermediate size for the interpolated frame. This intermediate shape is then placed at an appropriate intermediate location as described above.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A method for enhancing the playback of video frames comprising the steps of:
a) fetching a first actual frame;
b) fetching a second actual frame; and
c) determining whether to interpolate an intermediate frame for display between the display of the first actual frame and the second actual frame based on the first actual frame and the second actual frame; and
d) generating at least one interpolated frame based on the first actual frame and the second actual frame.

2. The method of claim 1 wherein the step of determining whether to interpolate an intermediate frame for display between the display of the first actual frame and the second actual frame includes
calculating a jumpiness factor based on the first actual frame and the second actual frame;
comparing the jumpiness factor with a predetermined threshold;
when the jumpiness factor is in a first predetermined relationship with the predetermined threshold, generating one or more interpolated frames by employing morphing technology.

3. The method of claim 2 wherein the step of calculating a jumpiness factor based on the first actual frame and the second actual frame includes
calculating a distance gap between two locations of a moving element;
determining whether the distance gap is in a first relationship with a predetermined threshold;
when the distance gap is in a first relationship with a predetermined threshold, generating one or more interpolated frames based on the first actual frame and the second actual frame.

4. The method of claim 1 wherein generating at least one interpolated frame based on the first actual frame and the second actual frame includes
detecting at least one moving element in the first actual frame and the second actual frame; and
generating the interpolated frame by performing morphing on the moving element.

5. The method of claim 1 further comprising:
performing edge-smoothing on the first actual frame;
performing edge-smoothing on the second actual frame;
displaying the first actual frame and the second actual frame.

6. The method of claim 5 further comprising:
performing edge-smoothing on the one or more of the interpolated frames.

7. The method of claim 1 further comprising:
performing post-processing techniques on the first actual frame, the second actual frame, or both the first actual frame and the second actual frame to improve the quality of the video stream.

8. The method of claim 7 further comprising:
performing post-processing techniques on the one or more of the interpolated frames.

9. The method of claim 1 further comprising:
performing special-effects techniques on the first actual frame, the second actual frame or both the first actual frame and the second actual frame to improve the quality of the video stream.

10. The method of claim 9 further comprising:
performing special-effects techniques on the one or more of the interpolated frames.

11. A method for enhancing the playback of video frames comprising the steps of:
a) fetching a first actual frame;
b) fetching a second actual frame; and
c) generating at least one interpolated frame based on the first actual frame and the second actual frame by using available computing power at the receiver;
wherein one of the clarity, resolution, and frame rate of the stream of frames is improved.

12. The method of claim 11 wherein
d) providing the first actual frame to a viewer;
e) providing the at least one interpolated frame to a viewer; and
f) providing the second actual frame to a viewer.

13. The method of claim 12
wherein the step of providing the first actual frame to a viewer includes the step of displaying the first actual frame;
wherein the step of providing the interpolated frame to a viewer includes the step of displaying the interpolated frame; and
wherein the step of providing the second actual frame to a viewer includes the step of displaying the second actual frame.

14. The method of claim 11 wherein the step of generating at least one interpolated frame based on the first actual frame and the second actual frame includes the step of
employing a morphing technique.

15. The method of claim 14 further comprising the steps of
for each pixel in the interpolated frame, generating an intensity that is based on the intensity of the corresponding pixels in the first actual frame and the second actual frame.

16. The method of claim 15 further comprising the steps of
for each pixel in the interpolated frame,
generating a red intensity that is based on the red intensity of the corresponding pixels in the first actual frame and the second actual frame;
generating a green intensity that is based on the green intensity of the corresponding pixels in the first actual frame and the second actual frame; and
generating a blue intensity that is based on the blue intensity of the corresponding pixels in the first actual frame and the second actual frame.

17. The method of claim 111 wherein the step of generating at least one interpolated frame based on the first actual frame and the second actual frame includes the step of
employing a frame interpolation algorithm that discriminates between moving portions of the frames and stationary portions of the frames.

18. A frame interpolator comprising:
a) an input for receiving a first actual frame;
b) an input for receiving a second actual frame; and
c) an intermediate frame generator for determining whether to generate one or more interpolated frames by employing a jumpiness factor and generating one or more interpolated frame based on the first actual frame and the second actual frame when the jumpiness factor is in a predetermined relationship with a predetermined value.

19. A video display system comprising:
a) a source of video data for providing a first actual frame and a second actual frame;
b) a viewer for displaying video data; and
c) a frame interpolator coupled to the source and viewer for determining whether to generate one or more interpolated frames by employing a jumpiness factor and generating one or more interpolated frame based on the first actual frame and the second actual frame when the jumpiness factor is in a predetermined relationship with a predetermined value.

20. The system of claim 19 wherein the video data is in one of a MPEG format, AVI format, MOV format, RM format, or any of a number of other movie file formats.

21. The system of claim 19 wherein the source of video data includes one of a hard drive, a removable storage, a server, a transmitter, and a frame buffer.

22. A video display system comprising:
a) a frame buffer for providing a first actual frame and a second actual frame
b) a viewer for displaying video data; and
c) a frame interpolator coupled to the source and viewer for determining whether to generate one or more interpolated frames by employing a jumpiness factor and generating one or more interpolated frame based on the first actual frame and the second actual frame when the jumpiness factor is in a predetermined relationship with a predetermined value.

23. The system of claim 22 wherein the video data is in one of a MPEG format, AVI format, MOV format, RM format, or any of a number of other movie file formats.

24. The system of claim 22 wherein the frame buffer is coupled to receive video data over a network.

25. The system of claim 22 wherein the video data is in the form of streaming video that is provided by a server that is disposed in a network.
